(19) United States
(12) Patent Application Publication
(10) Pub. No.: US 2010/0193416 A1
(43) Pub. Date: Aug. 5, 2010

(54) Non-biological removal and recovery of nutrients from waste

(76) Inventors: Ronald D. Barbaro, Southern Shores, NC (US); Ronald E. McIlwain, McLean, VA (US); David Muyan, Woodbury, NJ (US); Edward A. Weinberg, Richboro, PA (US)

Correspondence Address: Jeffery M. Lillywhite, PC, P.O. Box 1113, Draper, UT, 84020-1113, US

(21) Appl. No.: 12/322,345

(22) Filed: Jan. 30, 2009

(51) Int. Cl. C02F 9/02; C02F 1/42; B01D 36/00

(52) U.S. Cl. 210/102; 210/295; 210/259; 210/266

(57) ABSTRACT

An integrated process that includes liquid-solids separation and filtration system that treats swine or dairy feeding operations residual waste (manure flushwaters) for recovery of solid and dissolved nutrients for reuse and recycling of water from these wastes for a variety of uses. The system includes a coarse liquid/solids system to remove coarse material and multi stage, multimedia filter system that includes a set of modules. Each module includes screen assemblies and filter media sandwiched between the screen assemblies. A plurality of control assemblies is associated with each of the modules. The control assemblies include at least one external valve and are in fluid communication with a corresponding module to control flow through the corresponding module. The control assemblies selectively control fluid in each of the modules between at least one of: a forward flow through the screen assemblies to treat an influent flow, a bypass flow to bypass at least one of the modules, and a reverse flow provided through at least one of the modules.

### BACKGROUND OF THE INVENTION

1. Field of the Invention

The present invention relates to filtration equipment, and more particularly, to a non-biological removal and recovery of nutrients from waste.

2. Discussion of the Related Art

Various filtration systems have been developed for water purification, waste reclamation, fruit drink preparation or other solid/liquid separation. The filtration systems have included different sizes of filtration media that vary with the nature and size of the solids to be removed from the liquid phase. In these filtration systems, however, the flow path typically becomes occluded as the solids accumulate on the filter media. When the filtration system has become occluded, the filters must either be backwashed or removed from service in order to remove the accumulated solids. Solids smaller in size than the absolute micron rating of the filtration media will pass through the filter.

Another problem in filter systems is that the process must be interrupted to backwash the system. When backwashing or removing the system from service, the feed forward process is interrupted or shut-down to remove the accumulated solids from the filter media. The flow is diverted to a holding state or a recycle flow during the solids removal creating a backlog in the process. Additionally, once restarted, the flow must be tested to determine that the particles in the effluent are within the desired limits.

Another problem that exists in filtration systems is that the media becomes mixed during the backwashing or solids removal. Typically, the filter system includes a chamber having media that is varied from coarse to fine material. The flow starts with a coarse media to remove the larger solids, and then flows down to the finer media to remove the smaller particles. After the system has been backwashed, however, the media is mixed when the backwash flow pushes the finer media up through the coarse media. The backwash flow can also push the filter media to the edges of the chamber creating a short circuit through the media. Thus, after each backwashing, the filtration system can be rendered less effective.

### SUMMARY OF THE INVENTION

A series of filter systems treat swine or dairy waste. The system can include a coarse filtration system to remove coarse material and larger solids, for instance materials greater than 500 microns on order. A multi-stage, multi-media modular filter (MMMF) system includes a set of discrete modules. Each module includes screen assemblies and filter media sandwiched between the screen assemblies. A plurality of control assemblies is associated with each of the modules. The control assemblies include at least one external valve and are in fluid communication with a corresponding module to control flow through the corresponding module. The control assemblies selectively control fluid in each of the modules between at least one of: a forward flow through the screen assemblies to treat an influent flow, a bypass flow to bypass at least one of the modules, and a reverse flow provided through at least one of the modules to affect an automated backwash of collected solids from individual or all of the stages. The final filtration system in the process invention is dependent upon the discharge water quality objectives, and can range from adsorptive media or ion exchange beds or membrane filtration systems.

Optionally, the system ends with an NF or RO membrane filtration system, if the desired end product is high quality, drinking water. Otherwise, the end product water is reused as service water for the treatment process, or as spray irrigation. The process works equally in effectiveness with raw (undigested) wastes versus digested wastes. When applied to digested waste (digestate), the solids and liquids as a result of the process can be recycled back to the digester to enhance biogas production in quantity and on a digester volume (capacity) basis.

These and other features of the present invention, including the flexibility and adaptability to higher solids loading and finer particles inherent in manure flushwaters, will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments of the invention, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a schematic of a filtration system in accordance with an embodiment of the present invention;

FIG. 2 illustrates the overview of the filter system in accordance with an embodiment of the present invention; and

FIG. 3 illustrates another example of a process for non-biological removal and recovery of nutrients from waste.

### DESCRIPTION OF THE VARIOUS EMBODIMENTS

The subject of this application is a filtration system including various components, which may be implemented to filter a process flow. Although particular combinations of components are used to achieve a desired process flow, variations on those combinations can be used to achieve the desired liquid/solids separation results.

The present invention relates to a process for the non-biological removal and recovery of nutrients from raw manure flushwaters or from digested manure wastes that will reduce, if not eliminate, the negative environmental impacts from waste treatment lagoons and/or spray irrigation of these flushwaters per the current practice and in their place provide more solids-rich nutrients, recovery of soluble nutrients, and if desired, reusable water at a high recovery rate for relatively low cost.

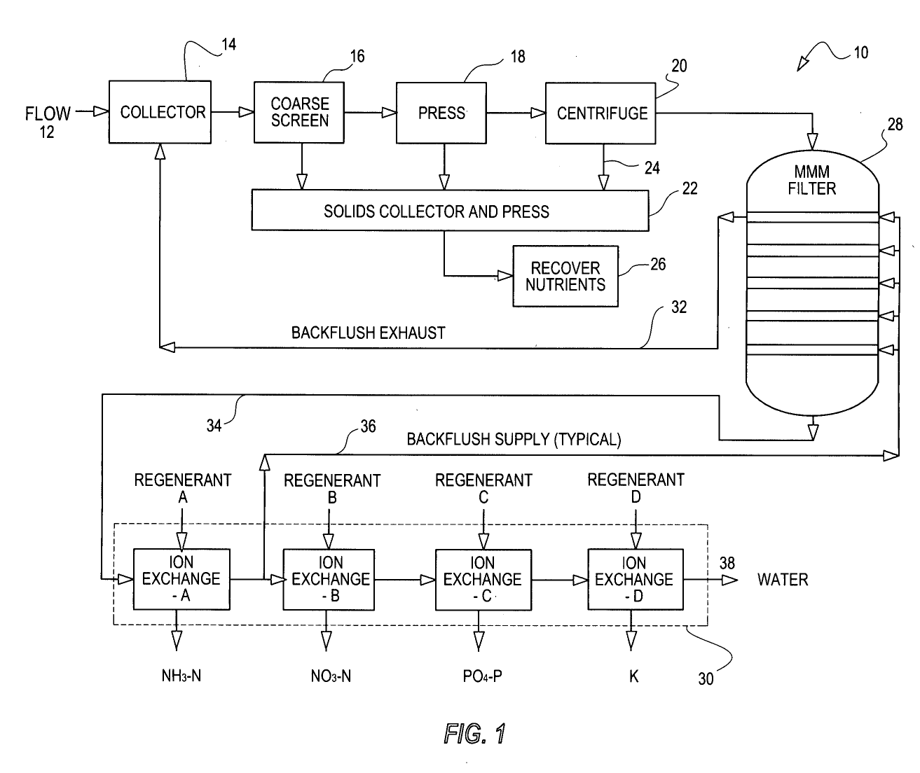

FIG. 1 illustrates a system 10 for directly removing and recovering nutrients from raw manure flushwater at facilities without a digester in place. The flow 12 is directed from barns, waste lagoons or pits using a coarse screen, presses, a centrifuge to filter and then downstream equipment for selective nutrient recovery of N, P or K. The water reuse may be used for service water, spray irrigation, and the like. The flow 12 can pass through a collector 14, a coarse screen 16, a press 18 and centrifuge 20. Solids can be collected from the coarse screen 16, press 18 and centrifuge 20 in a solids collector and press 22. Cake 24 can be pulled from the centrifuge 20 and directed to the solids collector and press 22. A device for recovering nutrients 26 can be added to the solids collector and press 22.

The flow 12 then can enter a multi-stage, multimedia modular filter 28 from the centrifuge 20. The processes shown are equally effective on swine or dairy (or other animal manures), any of which can be applied to manure flush waters or to biological processes (digested materials) depending upon the configuration of the MMMF media and downstream filtration systems to satisfy water quality and energy utilization objectives.

A non-biological based process removes and recovers nutrients and reuses water from: (1) raw manure flushwaters or (2) anaerobically digested manure flushwaters that have been pretreated using coarse screens, separators and/or presses. The process includes three steps or parts: (a) liquid/solids separation carried out by physical or chemical/physical means using a clarifier (and chemical aids for flocculation to promote sedimentation), (b) advanced, multi-stage, multimedia pressure modular filtration (MMMF) of the clarifier overflow (in step a) using the MMMF filtration system and (c) membrane filtration for reuse of the permeate water when animal drinking quality is desired of the effluent water discharge from the process. The effective removal of solids during these steps enables the recovery and reuse of the nutrients associated with these solids in the form of land application or other means currently practiced.

The first liquid/solids separation step (a) can also be achieved using centrifugation or electrocoagulation of the pretreated manure wastestream with or without the aid of chemical agents (e.g., polymers). Membrane filtration (c) using ultrafilters, nanofilters or reverse osmosis membranes are selected based on the desired water quality while optimizing total costs (capital and operating) and water recovery rates/rejects disposal. Moreover, if drinkable water is not desired, the third part (c) of the process (osmotic membrane filtration) is unnecessary or replaced with microfiltration, for example, if disinfection by non-chemical means, is desired, or by ion exchange for selective removal and recovery of specific dissolved nutrients.

The MMMF filter 28 can include, for example, regenerants A-D having a set of ion exchanges 30. The regenerant A can include an ion exchange media A selective for NH₃—N. The regenerant B can include an ion exchange media B selective for NO₃—N. The regenerant C can include an ion exchange media C selective for PO₄—P. The regenerant D can include an ion exchange media D selective for K. The effluent from the filter 28 and the ion exchange filters will return treated water.

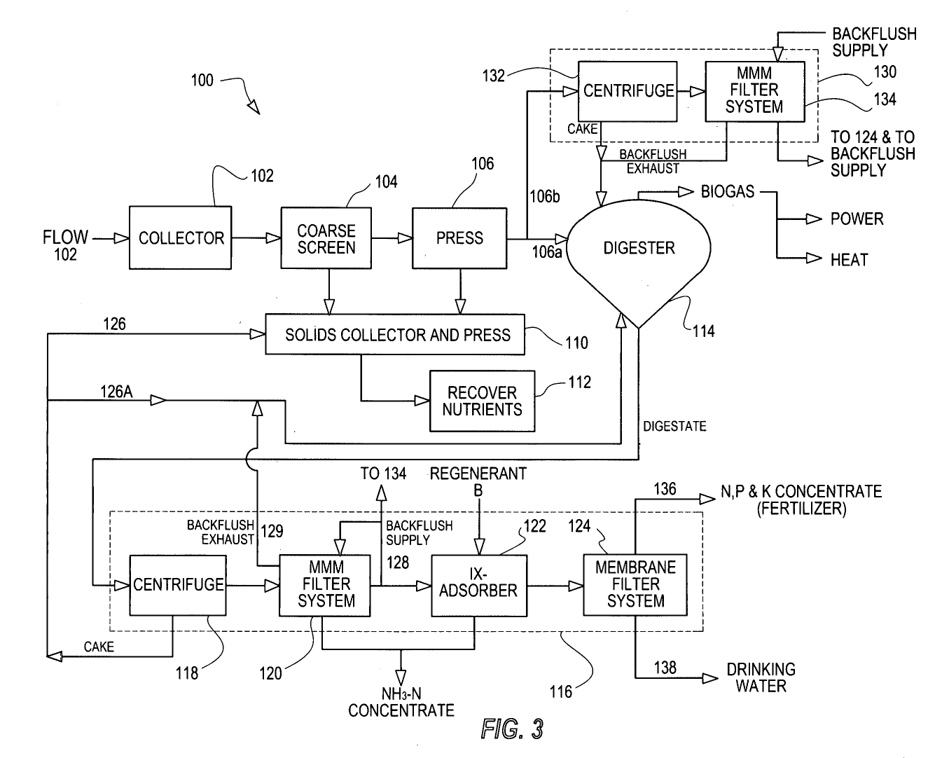

The centralized unit operation (b) can use the multi-stage, multimedia modular filter (MMMF) as a key component of the process because it provides the post clarifier (a) solids removal and the membrane pretreatment solids removal for the reliable operation of NF or RO systems, (c) or the clean operation of ion exchange beds (A, B, C and D). Furthermore, based on the nature of its design and configuration, MMMF Filter 28 provides the flexibility in the process to adapt to handling different manure waste streams (1 and 2 above), various animal feeding operations (dairy, swine, etc.) or variations within a given type of manure (swine sow vs. wiener vs. finishers, etc.) or other high solids organic wastes from food processors, and the like. as illustrated in FIG. 3, which is discussed in more detail below.

The advantages/benefits of the claimed process include: recovery of nutrients (N, P, K) and micronutrients associated with the solids separated by process parts (a) and (b) without intentional biological losses; recovery or reuse of soluble nutrients (N, P, K) associated with the concentrate (rejects) from membrane filtration (c); elimination (or significant size reduction) of waste treatment holding (or biological) lagoons due to the short residence or bed contact times (in minutes) required of each of the parts of the process (a), (b), or (c) compared to biological processing residence times (in hours or days) and the associated detrimental environmental impacts from their use; elimination of detrimental environmental impacts from sprayfields when drinking water quality effluent is generated and recycled/reused; flexibility to treat swine or dairy or other animal manure flushwaters directly or anaerobically digested waste (digestate) after biogas recovery; ability to provide improved solids feed control (recycle extended solids reduction) to enhance digester biogas production; and low maintenance requirements by using self-cleaning systems in (a), automatic backwashing systems in process (b) and self-cleaning systems in process (c). The backwashing flow 32 redirects the flow from the filter 28 to the collector 14 to reintroduce the stream to the filtration system 10.

The elimination of lagoons and/or sprayfields lead to numerous additional economic and environmental benefits; the use of sealed vessels and tanks replace open lagoons, eliminating or controlling odor problems; improved pathogen control leading to better animal health; and smaller footprint for operations, while lowering costs to treat and providing more available land for expansion of animal units.

When a digester is not available or is planned, the process takes manure flushwaters and effectively separates solids from liquids to enable, (in place of ion exchange selective nutrient removal) membrane filters and produces effluent water of drinking quality. The challenge in the past in dealing with this high strength waste is the predominance of fine solids (including submicron particles) that clog or impede adsorptive media, ion exchange resin and membrane filters.

The process illustrated in FIG. 1 overcomes these impediments by using the MMMF system 28 as the centrally poised unit to treat centrate (liquid discharge) from centrifuge (20) and pre-treat to remove/recover solids for reliable operation of ion exchange beds (or optionally, membrane filtration, not shown).

The flow process 12, beginning at the barns or waste holding lagoons or involves existing liquid/solids separation equipment of coarse screens (16), sand separators (for dairy flushwaters) and presses (18) that remove nutrient rich solids of significant size. The first part of the non-biological process, centrifugation (20), removes additional solids in the form of a cake 24, which is also rich in nutrients and readily added to the previously removed solids, thereby increasing the concentration/mass of nutrients for land application or other nutrient recovery means currently practiced in agricultural operations.

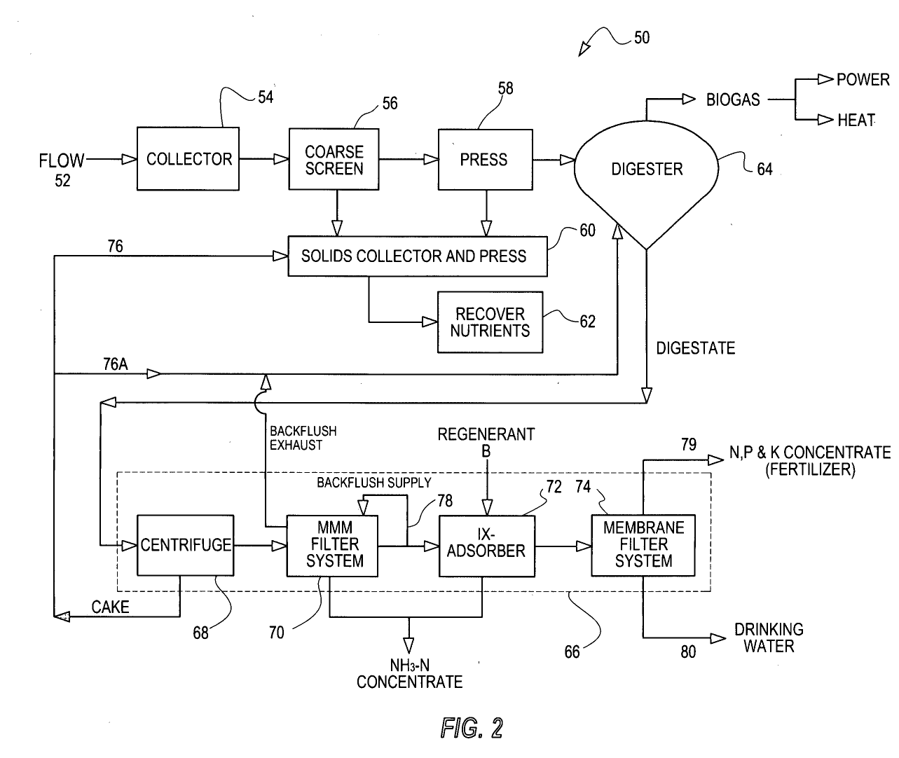

Before treatment of the centrate via ion exchange resin or adsorptive media to selectively remove soluble nutrients, additional liquid/solids separation is critical to allow these downstream media to operate reliably without plugging or fouling due to excessive solids still intact in the centrate. An MMMF filtration system (28) is a multimedia filter that can be adapted for fine filtration of centrate (or the fine floc created by electrocoagulation) allowing the downstream adsorbers (within boxed area 30) to operate efficiently and reliable with normal cleaning routines, which it would otherwise fail to do so without the rigorous two-step solids separation preceding it in this process (20, 28). MMMF (28) can be configured to effectively separate solids from the centrate in up to six stages. The multi-stage configuration of (28) allows tailored filtration and solids separation based on the particle size distribution of the solids in the discharge stream from (4). For example, if 6 stages are used that include anthracite, three distinct sand layers of decreasing size, two layers of natural zeolite and one layer of fine garnet, this is but one of a large number of configurable combinations of staged treatment for this application. Those practiced in the art of multi-stage multimedia modular filtration can affect the optimum configuration of the filter unit for use as a post-treatment device to (20) and a pretreatment device to downstream operations 30 and membrane filtration (not shown in FIG. 2, 1 of 3.

The use of multiple, shallow media beds allows the MMMF filter unit (5) to be backwashed using less volume of (filtered) water compared to conventional practice when using multi-media (but mono bed) filters. The backwash exhaust solution, loaded with agglomerated fine, nutrient-rich solids is recycled to the head of the process coarse screen operation), for removal by operations 2, 3 or 4.

Moreover, the introduction of natural zeolite in one or more of the layers, in addition to finer filtration (compared to rapid sand filtration, for example), will also adsorb ammonia from the liquid removing N nutrient from the stream. The N ammonia can be recovered when the zeolite is regenerated using a caustic solution. Being a shallow bed of up to six stages, it is preferred that an additional adsorber loaded as a monobed (30-A) of zeolite follows the system and adds capacity for more complete recovery of N ammonia nutrient. Solids that may accumulate in the bed of (30-A, 30-B, etc.) are automatically backwashed in the same fashion but much less frequently because of fine solids removal by MMMF (28) and directed to (14) as backwash solution. In addition to (30-A), adsorbers loaded with ion exchange resin specific for nitrate (N), phosphate (P) or potassium (K) can be used in a train (Ion Exchange B, Ion Exchange C for PO4 and ion exchange D for K 30 A), (B\), (C) to selectively remove nutrients for recovery via regeneration, if desired for advanced nutrient management.

The lagoons represent 1) a large stockpile of water that the farm cannot use to feed or wash down animals with and 2) the nitrogen and phosphate levels interfere with the unlimited distribution of the water to an irrigation system because the soil cannot accept additional nutrient load or utilize the nutrients fast enough.

FIG. 2 illustrates a system 50 used to remove and recover nutrients from digester waste (digestate, sludge). A biological system in an anaerobic digester processes raw manure waste to produce biogas and digestate. Using a centrifuge, the MMMF filter and membrane filter produces drinking water quality for reuse and N (ammonia) and P—K concentrated solutions for nutrient recovery derived from the raw manure waste or the digested waste. The system can also include a process without a filter. The flow 52 is directed from barns, waste lagoons or pits using a digester to process the waste. The flow 52 can pass through a collector 54, a coarse screen 56, and a press 58. Solids can be collected from the coarse screen 56 and press 58 in a solids collector and press 60. A device for recovering nutrients 62 can be added to the solids collector and press 60.

For the animal feeding operation with anaerobic digestion 64, the first step involves separating manure flushwaters from an anaerobic digester (digestate) into digested solids, liquids and biogas. The invention processes the digested solids and liquids, while the biogas is captured and conditioned for use in cogeneration of power and heat.

The process' first step in effecting liquids/solids separation can be achieved via a clarifier, centrifuge (20) or electrocoagulation to affect a coarse, bulk solids separation. The digestate from the digester 64 flows to a secondary process system 66, which includes a centrifuge 68, an MMMF filter system 70, an AX adsorber 72 and a membrane filter system 74. The centrifuge 68 or electrocoagulation system (not shown) are preferred for the first liquids/solids separation because they do not involve the storage, handling, dosing of chemical aids (as does clarification), thus providing easy to use low maintenance systems (and related labor costs) compared to the use of clarifiers. In the case of centrifugation, the resultant solids cake 76 is directed to the “solids” collection pile of pre-screened materials (60) that were removed before digestion and equally rich in nutrients associated with these solids. Backwashing flow 78 can redirect the flow through the filter 28 for cleaning whereby the exhaust is directed to Digester 64.

The MMMF filter is uniquely adapted to follow the clarifier or centrifuge (centrate) and thus protect downstream unit operations, for example, RO, NF, ion exchange from fouling. By adapting the system with the filter at the centrifuge and clarifier, the tests have verified successful results in various waste treatment facilities. The results show efficient treatment by the MMMF at a low cost for high filter solids loading (up to as much as 3000 mg/L Total Suspended Solids) and fine micron sized solids (as small as 2 to 3 microns diameter).

Before treatment of the centrate through membrane filtration to produce potable water for reuse, additional liquid/solids separation allows membranes to operate reliably without plugging or fouling due to excessive solids still intact in the centrate. A filtration system (6) is a multi-media filter that can be adapted for fine filtration of centrate (or the fine floc created by electrocoagulation) allowing the membrane filter (8) to operate efficiently and reliably with normal cleaning routines, which it would otherwise fail to do so without the rigorous two-step solids separation preceding it in this process. Item (6) can be configured to effectively separate digester solids from the centrate in up to six stages. The multi-stage configuration of (6) allows tailored filtration and solids separation based on the particle size distribution of the solids in the discharge stream from digester (28). For example, if 6 stages are used that include anthracite, two distinct sand layers of decreasing size, two layers of natural zeolite and one layer of fine garnet, this is but one of a large number of configurable combinations of staged treatment for this application. Those practiced in the art of multi-stage, multimedia modular filtration can affect the optimum configuration of the filter unit for use as a post-treatment device to (68) and a pretreatment device to downstream operations (72) and (74).

The use of multiple, shallow media beds allows the MMMF filter unit (70) to be backwashed using less volume of (filtered) water compared to conventional practice when using multi-media (but mono bed) filters. The backwash exhaust solution, loaded with fine solids is recycled to the digester (64), as prime seed material. In addition, cake material from centrifuge (76A) can be mixed in for advanced solids feed control for enhanced digester biogas production, in the form of extended solids retention. If there is no digester, the backwash solution (at approximately 1% of the feed forward volume) is directed back to the pretreatment coarse screen operation for collection and recovery of nutrient rich solids, FIG. 1, stream 32.

Moreover, the introduction of natural zeolite in one or more of the layers, in addition to finer filtration (compared to rapid sand filtration, for example), will also adsorb ammonia from the liquid removing N nutrient from the stream. The N ammonia can be recovered when the zeolite is regenerated using a caustic solution. Being a shallow bed of up to six stages, it is preferred that an additional adsorber loaded as a monobed (72) of zeolite follows the MMMF system (70) for more complete recovery of N ammonia nutrient. Solids that may accumulate in the bed of (72) are automatically backwashed in the same fashion but much less frequently because of the fine solids removal by MMMF, (70) and directed to (64) as additional seed material. In lieu of or in addition to (72) and adsorber loaded with ion exchange resin specific for phosphate can be used to selectively remove P nutrient, if desired, or N-nitrate if desired, for advanced nutrient management. Thus, selective removal of nutrients (N, P or K) can be accomplished downstream of the filter and upstream of the membrane filter for advanced, selective nutrient management by removal and recovery of dissolved nutrient species. Removal and recovery of nutrients by RO membrane in comparison will not be selective: N, P and K will be concentrated in the RO rejects (76).

FIG. 3 illustrates another example of a system 100 with digester (biogas) enhancements for non-biological removal and recovery of nutrients from waste. The system 100 includes recycle of digested solids recovered by the centrifuge (126A) and backwash solution (128) to affect extended solids retention (ESR), which is refined with enhanced solids removal when a MMMF (120) is added as the central unit.

The system 100 splits a flow 106b to a second treatment train consisting of another centrifuge (132) and MMMF filter (130). A significantly smaller digester (114) can be designed because the centrifuge and filter (130) remove the liquid portion of the split flow and recycle the separated centrifuge cake solids and the MMMF filter backwash exhaust. The reduced size of the digester provides significant economic benefit because the capital cost savings (and operating cost savings to heat) for the smaller digester is greater than the capital cost of adding the centrifuge and filter equipment.

The processes illustrated in FIGS. 2 and 3 improve the production rate of biogas from the digester for additional payback from both forms of enhancements. The system shown in FIG. 3 is similar to the system of FIG. 2, other than the flow is split into train streams 106a and b, utilizing treatment train 130. In FIG. 3, the system 100 is used to remove and recover nutrients from digester waste (digestate, sludge). A biological system in an anaerobic digester processes raw manure waste to produce biogas and digestate. Using a centrifuge (118), the MMMF filter (120) and membrane filter (124) produces drinking water quality for reuse (138) and N (ammonia) and P-K concentrated solutions (136) for nutrient recovery derived from the raw manure waste or the digested waste. The flow 102 is directed from barns, waste lagoons or pits using a digester (114) to process the waste and produce biogas. The flow 102 can pass through a collector 102, a coarse screen 104, and a press 106. Solids can be collected from the coarse screen 106 and press 108 in a solids collector and press 110. A device for recovering nutrients 112 can be added to the solids collector and press 110.

The manure flushwaters are separated into trains 106a and b before an anaerobic digester) 114 into digested solids(digestate, sludge), liquids and biogas. The invention processes the digested solids and liquids, while the biogas is captured and conditioned for use in cogeneration of power and heat.

In train a, the digestate from the digester 114 flows to a secondary process system 116, which includes a centrifuge 118, a filter system 120, an IX adsorber 122 and a membrane filter system 124. The centrifuge 118 (or electrocoagulation system) provides easy to use, low maintenance systems (and related labor costs) compared to the use of clarifiers. In the case of centrifugation, the resultant solids cake 126 is directed to the “solids” pile of pre-screened materials (overs) that were removed before digestion and equally rich in nutrients associated with these solids. Backwashing flow (128) exhausts from the MMMF filter 120 and its solids from 120 are directed to the digester as an ESR enhancement.

In train b, the flow is split and directed to another secondary system 130. The other secondary system 130 includes a centrifuge 132 and an MMM filter system 134. The backwash exhaust from the filter system 134 is redirected to the digester 114 diluting cake from centrifuge 132 along the way to introduce it into digester 114.

The systems treat water for reuse by removing and capturing the nutrient as part of the overall system. In this way, both of these concerns could be mitigated and potentially result in three beneficial products as revenue streams for animal feed operators that implement the process: 1.) enhanced production of biogas, 2.) multiple liquid and solid fertilizer products from the recovered solids for fertilizer production, soil amendment, bedding, and the like, and 3.) reusable water.

The lagoon associated with the research facility is the smallest. The system starts with the smaller lagoon for a number of reasons: the lagoon can be drawn down the quickest at the lowest cost; easier to manage a smaller system to demonstrate performance; and smaller amounts of by-product fertilizer to reuse or to market.

The system also provides for pathogen control (disinfection) when a digester is not available for this function. This leads to selecting electrocoagulation (EC) as the bulk workhorse liquids/solids separator (a) (over centrifuging). The electric fields EC sets up in the waste streams effectively removes solids and also “, deactivate these pathogens via cell wall destruction. For example, e coli colony counts can be reduced 4 logs (ten-fold or by 10,000) as a result of EC. Hence, much less disinfecting chemical agent would need to be added before the recycled water is sent back to the barns as drinking water. Centrifuging does little for pathogen control in comparison. The MMMF filter unit has been demonstrated to be a superior separation/dewatering device for the finer pin flocs created by EC. It is the central piece as pre-treatment for the RO membrane system to keep the membrane clean. It will serve the same purpose, if selective ion exchange (IX) resin is used to remove soluble P and N for recovery by regeneration. Without MMMF pretreatment, IX resin beds need constant backwashing to maintain clean surfaces free from fine manure solids for efficient ion exchange. The same is true for disinfection equipment that relies on UV lamps. Without MMMF filtration as pretreatment, lamps become dirty and less effective in disinfecting the discharge stream.

There are two choices of nutrient selective exchange resins or adsorption media: regenerable and disposable. Regenerable resins use chemical agents to replace the exchanged species (nutrients) whereas disposal resins once exhausted are manually replaced with fresh media. The spent material can be used as soil amendments for release of N or P. The concentrations of other important ionic species, (e.g., sulfates, bicarbonates and chlorides) are needed for proper selection of these selective resins, as practiced by those skilled in the art of ion exchange. Depending on the complete water quality profile, a multiple train of polishing IX resin beds may be sufficient to produce drinking water quality without the need for membrane filtration (c).

To summarize, a treatment train can include a centrifuge (or an electrocoagulation system), an MMMF filter system, P-selective IX resin vessel, N-selective IX resin vessel, IX regeneration systems, and/or a membrane filtration system, and holding and surge tanks and pumps.

The process invention resides in the novel features of form, construction, and arrangement of parts and components described herein. The process description shows that modifications may be made to the illustrated embodiment of the invention through the unique configuration of the central MMMF filtration system, or the preceding and proceeding equipment components without departing from the spirit and scope of the invention as described herein for manure flushwaters, or for other organic wastes of complex nature and significant suspended solids loading.

The present invention may be embodied in other specific forms without departing from its spirit or essential characteristics. For example, the quantity of stages and the type/sequence of MMMF filter media, the type of ion exchange units, and the type of membrane filtration are determined by the specific characteristics of the particular flow to be treated and the water quality objectives for safe discharge or reuse/recycle.

A treatment train consisting of EC (a), MMMF (b), and any of the desired (c) polishing components is well suited to package in a mobile treatment container or trailer for use at multiple small or medium sized animal feeding operations or the like.

The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An integrated liquid-solid separation and filtration system to treat animal manure wastes or digested materials from a source, the system comprising:
a coarse liquid-solids separation system to remove coarse material;
a multi-stage, multi media modular filter system including a set of modules, each module including screen assemblies and filter media sandwiched between the screen assemblies; and
an optional membrane filter system to produce high purity water of animal drinking water quality for reuse.

2. The system of claim 1, wherein the coarse liquid-solids separation is affected by centrifugation, clarification, sedimentation, or electrocoagulation unit operations.

3. The system of claim 1, wherein the multi-stage, multi media modular filter system includes a plurality of control assemblies associated with each of the modules, each of the control assemblies including at least one external valve and being in fluid communication with a corresponding module to control flow through the corresponding module, the control assemblies selectively controlling fluid in each of the modules between at least one of
a forward flow through the screen assemblies to treat an influent flow,
a bypass flow to bypass at least one of the modules, and
a reverse flow provided through at least one of the modules.

4. The system of claim 3, wherein the multi-stage, multi media modular filter system includes a tailored configuration of custom media in up to six layers based on the particle size distribution discharged from the coarse liquid-solids separation upstream operation.

5. The system of claim 3, wherein the multi-stage, multi media modular filter system is configured to filter influent waste streams with solids loading as great as 3000 mg/L total suspended solids and particle sizes as small as 2 microns and, produce a small volume (approx. 1% of the feed forward) of backwash solution in an automated fashion, depending upon the specific media configuration used.

6. The system of claim 3, wherein the sequential treatment of coarse liquid solids separation and the multi-stage, multi media modular filter system will effectively remove nutrient rich solids for recovery from animal manure residuals and effectively pretreat waste streams for reliable operation of NF or RO membrane filtration.

7. The system of claim 3, wherein a natural zeolite is added within a desired sequence of the multi-stage, multi media modular filter layers and/or a monobed of natural zeolite is added post multi-stage, multi media modular filter system, ammonium ion (NH3 as NH4+) is removed and recovered via regeneration of the natural zeolite before the RO membrane, which would otherwise permeate the membrane detrimentally affecting the water quality discharge.

8. The system of claim 3, wherein a backwash volume of the multi-stage, multi media modular filter is stored in a holding tank and when mixed with recovered solids from the coarse liquid-solids separation and recycled back to an anaerobic digester, biogas from the digester increases due to extended solids retention within the digester.

9. The system of claim 3, wherein when clarification or sedimentation is not used for coarse liquid solids separation and centrifugation or electrocoagulation, the low-profile, modular equipment are designed to fit into a container for mobile treatment of nutrient removal and recovery from a farm site.

10. The system of claim 3, wherein a sequence of treatment operations and a specific multi-stage, multi media modular filter configuration to other waste streams containing organics, solids, metals or other recalcitrant species, such as radionuclides, are configured for the removal of the offending species, such as solids, dissolved species, organics, such wastes streams being produced water from oil and gas drilling operations or landfill leachate in stationary or fixed system.

11. The system of claim 1, wherein the optional membrane system includes nanofiltration (NF) or reverse osmosis (RO) membranes for the production of high purity water effluent for reuse and the recovery of soluble nutrients (N, P and K), also for reuse or resale as fertilizer solution.

12. The system of claim 1, wherein the system is designed for digested or undigested waste materials, such that if the influent flow to the digester is split between the digester and a smaller capacity coarse liquid-solids separator followed by a smaller capacity multi-stage, multi media modular filtration system, the recovered solids in an undigested state and minimal backwash solution from the multi-stage, multi media modular filter system will also enhance a “high solids” digester's biogas production by replacing waste liquid with waste volatile solids, wherein a smaller capacity digester using split flow can be used to make as much or more biogas than a larger full flow digester because the solids concentration is greater and the liquid volume is less.

13. A process in an integrated liquid-solid separation and filtration system to treat animal manure wastes or digested materials from a source, the process comprising:
removing coarse material with a coarse liquid-solids separation system;
treating the waste stream with a multi-stage, multi media modular filter system, the filter system including a set of modules, each module including screen assemblies and filter media sandwiched between the screen assemblies; and
treating the stream from the filter system with an optional membrane filter system to produce animal drinking water quality for refuse.

14. The process of claim 13, wherein the act of treating with the multi-stage, multi media modular filter system includes a plurality of control assemblies associated with each of the modules, each of the control assemblies including at least one external valve and being in fluid communication with a corresponding module to control flow through the corresponding module, the control assemblies selectively controlling fluid in each of the modules between at least one of
a forward flow through the screen assemblies to treat an influent flow,
a bypass flow to bypass at least one of the modules, and
a reverse flow provided through at least one of the modules.

15. The process of claim 14, wherein the multi-stage, multi media modular filter system filters influent waste streams with solids loading as great as 3000 mg/L total suspended solids and particle sizes as small as 2 microns and, produce a small volume (approx. 1% of the feed forward) of backwash solution.

16. The process of claim 14, wherein the sequential treatment of coarse liquid solids separation and the multi-stage, multi media modular filter system removes nutrient rich solids for recovery from animal manure residuals and pretreats waste streams for reliable operation of NF or RO membrane filtration.

17. The process of claim 14, further comprising an act of adding a natural zeolite within a desired sequence of the multi-stage, multi media modular filter layers and/or adding a monobed of natural zeolite post multi-stage, multi media modular filter system, ammonium ion (NH3 as NH4+) being removed and recovered via regeneration of the natural zeolite before the RO membrane, which would otherwise permeate the membrane detrimentally affecting the water quality discharge.

18. The process of claim 14, further comprising an act of storing a backwash volume of the multi-stage, multi media modular filter in a holding tank and when mixed with recovered solids from the coarse liquid-solids separation and recycled back to an anaerobic digester, biogas from the digester increases due to extended solids retention within the digester.

19. The process of claim 14, further comprising a sequence of treatment operations and a specific multi-stage, multi media modular filter configuration to waste streams containing organics, solids, metals or other recalcitrant species, such as radionuclides, to remove offending species in the waste streams in water from oil and gas drilling operations or landfill leachate in stationary or fixed system.

20. The process of claim 13, further comprising an act of splitting the influent flow between a digester and a coarse liquid-solids separator followed by the multi-stage, multi media modular filtration system, the recovered solids in an undigested state and minimal backwash solution from the multi-stage, multi media modular filter system will also enhance a “high solids” digester's biogas production by replacing waste liquid with waste volatile solids, using the digester to make as much or more biogas than a larger full flow digester by increasing the solids concentration and reducing the liquid volume.
